(19) United States
(12) Patent Application Publication
(10) Pub. No.: US 2019/0138570 A1
(43) Pub. Date: May 9, 2019

(54) Apparatus and Methods for Performing Multiple Transcendental Function Operations

(71) Applicant: Cambricon Technologies Corporation Limited, Beijing (CN)

(72) Inventors: Shijin Zhang, Beijing (CN); Shangying Li, Beijing (CN); Tianshi Chen, Beijing (CN); Yunji Chen, Beijing (CN)

(21) Appl. No.: 16/097,603

(22) PCT Filed: Apr. 29, 2016
(86) PCT No.: PCT/CN2016/080690

§ 371 Date: Oct. 29, 2018

(51) Int. Cl. G06F 17/17; G06F 7/548; G06F 7/556; G06F 17/16

(52) U.S. Cl. CPC G06F 17/17; G06F 17/16; G06F 7/556; G06F 7/548

(57) ABSTRACT

The present invention discloses an apparatus and a method for performing a variety of transcendental function operations. The apparatus comprises a pre-processing unit group, a core unit and a post-processing unit group, wherein the pre-processing unit group is configured to transform an externally input independent variable a into x, y coordinates, an angle z, and other information k, and determine an operation mode to be used by the core unit; the core unit is configured to perform trigonometric or hyperbolic transformation on the x, y coordinates and the angle z, obtain transformed x′, y′ coordinates and angle z′, and output them to the post-processing unit group; and the post-processing unit group is configured to transform the x′, y′ coordinates and the angle z′ input by the core unit according to the other information k and a function f input by the pre-processing unit group to obtain an output result c. The present invention solves the problems of excessive overheads in the general-purpose processor manner and poor precision in the pure linear approximation manner, and efficiently strengthens the support for various transcendental function operations.

### TECHNICAL FIELD

The present invention relates to the technical field of transcendental function operation, specifically to an apparatus and a method for performing multiple transcendental function operations, and particularly to an apparatus and a method for performing trigonometric, hyperbolic, exponential or logarithmic function operations.

### BACKGROUND

Transcendental functions such as trigonometric, hyperbolic, exponential, and logarithmic functions are often used not only in all kinds of scientific computing, but also as activation functions in multi-layer artificial neural networks. Multi-layer artificial neural networks are widely used in the fields of pattern recognition, image processing, function approximation, optimization computing, etc. and they have received wide attention from academia and industrial community in recent years because of their high recognition precision and good parallelism.

One known method that supports calculations of the above-mentioned kinds of transcendental functions is to use a general-purpose processor. This method approximates various transcendental functions by using general-purpose register files and general-purpose functional units to execute general instructions. One of the disadvantages of this method is that it cannot be integrated with dedicated devices of multi-layer artificial neural networks, and as a result, the other steps cannot get benefit from the performance enhancement of such devices. In addition, a general-purpose processor needs to decode transcendental function calculation into a long list of operations and memory access instruction sequences, and the front-end decoding of the processor brings about high overheads in power consumption.

Another method to calculate transcendental functions in multi-layered artificial neural networks is linear approximation. This method approximates activation functions (many of which are transcendental functions) by dividing the domain of definition into segments and storing the coefficients of the linear approximations for respective segments. The disadvantage of this method is that the number of the segments into which the domain of definition can be divided for piecewise linear approximation is limited, so the precision cannot meet the needs of the development of artificial neural networks, and the method cannot be used for applications requiring higher precision, such as scientific computing and image processing.

### SUMMARY

In view of the foregoing, the major object of the present invention lies in providing an apparatus and a method for performing multiple transcendental function operations to solve the problems of excessive overheads in the general-purpose processor manner and poor precision in the pure linear approximation manner, so as to strengthen the support for various transcendental function operations.

In order to achieve the above object, the present invention provides an apparatus for performing multiple transcendental function operations, the apparatus comprising a pre-processing unit group, a core unit and a post-processing unit group, wherein:
the pre-processing unit group is configured to transform an externally input independent variable a into x, y coordinates, an angle z, and other information k, and determine an operation mode to be used by the core unit;
the core unit is configured to perform trigonometric or hyperbolic transformation on the x, y coordinates and the angle z, obtain transformed x′, y′ coordinates and angle z′, and output them to the post-processing unit group; and
the post-processing unit group is configured to transform the x′, y′ coordinates and the angle z′ input by the core unit according to the other information k and a function f input by the pre-processing unit group to obtain an output result c.

In the above solution, the pre-processing unit group comprises a selector 1 and a processor 2, and the post-processing unit group comprises a first post-processing unit 4, a second post-processing unit 5 and a third post-processing unit 6, wherein the selector 1 receives the externally input independent variables a and the externally input function f, and determines which one of the following four different operations should to be taken, the details being set out as follows:

I. if, under the specification adopted for input or output, the error between the result of the linear or quadratic approximation of the independent variable a and the true value thereof is limited to the last bit of mantissa in a case the result and the true value are respectively represented by floating-point numbers, resulting in that the independent variable a is too small, then the selector 1 directly outputs the independent variable a and the function f to the first post-processing unit 4 in the post-processing unit group, and the first post-processing unit 4 obtains a linear approximation formula of the independent variable a based on the function f, and performs addition and multiplication on the independent variable a to get the output result c;

II. if the independent variable a is not beyond the convergence domain of the core unit; it is possible to reach the angle z=0 in a default mode or the ordinate y=0 in a vector mode within a limited number of steps; and the independent variable a can be directly accepted by a corresponding mode of the core unit 3, then the selector 1 obtains the x, y coordinates and the angle z of the independent variable a, and the mode to be used by the core unit according to the function f, and outputs the x, y, z, and the mode to the core unit 3; the core unit 3 performs trigonometric or hyperbolic transformation on the x, y, and z based on the mode, obtains transformed x′, y′ coordinates and an transformed angle z′, and outputs them to the second post-processing unit 5 in the post-processing unit group; and the second post-processing unit 5 obtains the output result c based on the x′, y′ coordinates and the angle z′ output by the core unit and the function f;

III. if the independent variable a cannot be directly accepted by a corresponding mode of the core unit 3, then the selector 1 hands over the independent variable a and the function f to the processor 2 for pre-processing, and the processor 2 performs information decomposition processing on the independent variable a according to the function f, and obtains the x, y coordinates, the angle z, the mode to be used by the core unit 3, and the other information k, wherein the x, y coordinates, the angle z, and the mode to be used by the core unit 3 are the same as those in II; the x, y coordinates, the angle z, and the mode to be used by the core unit 3 are output to the core unit 3; and the other information k and the function f are directly output to the third post-processing unit 6 in the post-processing unit group; the core unit 3 performs trigonometric or hyperbolic transformation on the x, y, and z based on the mode, obtains the x′, y′, and z′, and outputs them to the third post-processing unit 6 in the post-processing unit group; and the third post-processing unit 6 obtains the output result c based on the x′, y′, and z′ output by the core unit 3, the k given by the processor 2, and the function f; and

IV. if, under the specification adopted for input or output, the true value of the independent variable a exceeds the maximum range of the values represented by floating-point numbers, then the selector 1 directly outputs the independent variable a and the function f.

In the above solution, under the specification adopted for input or output in the IV, the true value of the independent variable a exceeds the maximum range of the values represented by floating-point numbers, as for IEEE754 half-precision floating-point number, the maximum range is the maximum absolute value of (1024+1023) or 1024×2³⁰⁻¹⁵=65504.

In order to achieve the above object, the present invention further provides a method for performing multiple transcendental function operations, the method comprising:

Step 1: the selector receives the input independent variable a and the input function f, and determines which one of the four different operations, namely, Type I, Type II, Type III, and Type IV should be adopted;

Step 2: when the processor adopts the Type III operation, the processor performs multiplication or shift transformation on the input independent variable a and the input function f so that they can be accepted by the core unit, and records transformation information k and a sign for use by the third post-processing unit, wherein the sign is valid only in a part of functions;

Step 3: when the processor adopts the Type II or Type III operation, the core unit implements the following four types of trigonometric or hyperbolic transformation by addition, subtraction, and shift operations on three numbers, i.e., the abscissa x, the ordinate y, and the angle z:

$$Trigonometric default \text{:}$$

$$( x , y , z ) \to ( A ( x cos z - y sin z ) , A ( y cos z + x sin z ) , 0 )$$

$$Trigonometric vector \text{:} ( x , y , 0 ) \to ( A \sqrt{{x}^{2} + {y}^{2}} , 0 , arc tan \frac{y}{x} )$$

$$Hyperbolic default \text{:}$$

$$( x , y , z ) \to ( B ( x cos h z + y sinh z ) , B ( y cosh z + x sinh z ) , 0 )$$

$$Hyperbolic vector \text{:} ( x , y , 0 ) \to ( B \sqrt{{x}^{2} - {y}^{2}} , 0 , arc tanh \frac{y}{x} )$$

wherein in the above formulae, A and B are constants related to the selected number of iterations, and the shift operation is to multiply by a power of 2;

Step 4a: when the processor adopts the Type I operation, the first post-processing unit calculates a linear or quadratic approximation according to the input function f and outputs the approximation; and

Step 4b: when the processor adopts the Type II or Type III operation, the second post-processing unit performs addition, subtraction, multiplying by a constant, division, and shift operations on the output of the core unit according to the input function f and the information provided by the processor of the pre-processing unit group, and obtains the output result c, wherein the information provided by the processor of the pre-processing unit group is valid only in the Type III operation.

As can be seen from the above technical solutions, the apparatus and the method for performing multiple transcendental function operations provided by the present invention coverts evaluation of transcendental functions into getting the results of trigonometric or hyperbolic rotation transformation; adopts the manner of iteration to ensure a fixed absolute value of the angle of each rotation; performs backward rotation when the rotation is excessive and performs forward rotation when the rotation is insufficient, so that it is only necessary to store a series of fixed coefficients and define an angle sequence zᵢ to make tan zᵢ(tan hzᵢ in the case of hyperbolic transformation) a power of 2, so that the multiplication of them by the x, y coordinates can be implemented by much simpler shifting. Accordingly, it reduces waste of time or power consumption caused by multiplication performed between each two of variables, and guarantees the required precision, and thus it can carry out calculations of various trigonometric, hyperbolic, exponential, and logarithmic functions, solves the problems of excessive overheads in the general-purpose processor manner and poor precision in the pure linear approximation manner, and efficiently strengthens the support for various transcendental function operations.

### BRIEF DESCRIPTION OF THE DRAWINGS

For a more complete understanding of the present invention and its advantages, reference will now be made to the following description with the drawings, in which:

FIG. 1 shows a schematic diagram of the structure of the apparatus for performing multiple transcendental function operations according to an embodiment of the present invention.

FIG. 2 shows a schematic diagram illustrating that the core unit in FIG. 1 iteratively approximates the target trigonometric function relation in the trigonometric mode.

FIG. 3 shows a schematic diagram illustrating that the core unit in FIG. 1 iteratively approximates the target hyperbolic function relation in the hyperbolic mode.

FIG. 4 shows a flowchart of the method for performing multiple transcendental function operations according to an embodiment of the present invention.

Table 1 shows the specific operations conducted by each unit under the conditions of respective input functions f and independent variables a according to the embodiments (using 16-bit floating-point numbers) of the present invention. These operations can be implemented mainly by addition, subtraction, multiplying a constant, and shift (multiplying or dividing by a power of 2), and only a few of them are implemented by division and multiplication requiring low precision (in the case of quadratic approximation). If the precision required by input and that required by output are different, some of the ranges in Table 1 should be adjusted accordingly.

### DETAILED DESCRIPTION

The other aspects, advantages, and prominent features of the present invention will become apparent to those skilled in the art in view of the following detailed description, combine with the drawings, of exemplary embodiments of the present invention.

In the present invention, the terms “comprise” and “contain” and derivatives thereof are intended to be inclusive but not limiting; the term “or” is inclusive, meaning and/or.

In the present specification, the following embodiments for describing the principles of the present invention are merely illustrative and should not be construed in any way as limiting the scope of the invention. The following description with reference to the drawings is provided to assist in a comprehensive understanding of the exemplary embodiments of the present invention as defined by the claims and their equivalents. The following description includes various specific details to assist in that understanding but these details should be regarded as merely exemplary. Therefore, those of ordinary skill in the art should realize that various changes and modifications of the embodiments described herein can be made without departing from the scope and spirit of the present invention. In addition, description of well-known functions and structures is omitted for clarity and conciseness. Moreover, the same reference numerals are used for similar functions and operations throughout the drawings.

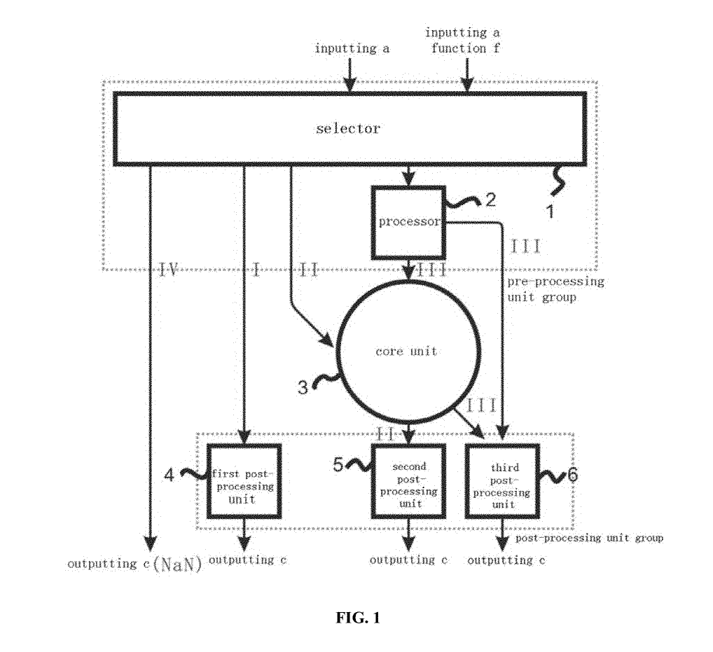

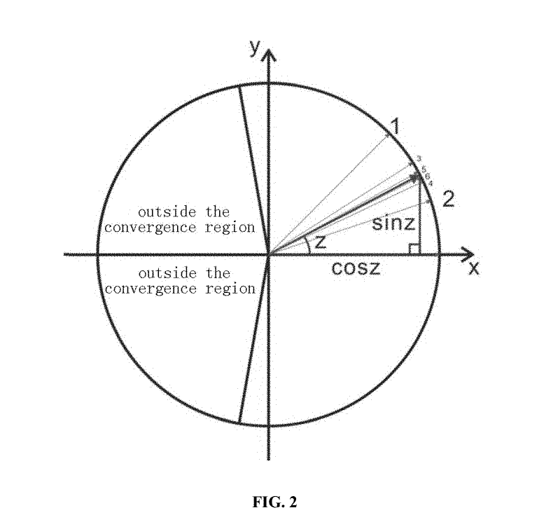

FIG. 1 shows a schematic diagram of the structure of the apparatus for performing multiple transcendental function operations according to an embodiment of the present invention. As shown in FIG. 1, the apparatus comprises a pre-processing unit group (1 and 2), a core unit 3 and a post-processing unit group (4, 5 and 6), wherein:

the pre-processing unit group is configured to transform an externally input independent variable a into x, y coordinates, an angle z, and other information k, and determine an operation mode to be used by the core unit;

the core unit 3 is configured to perform trigonometric or hyperbolic transformation on the x, y coordinates and the angle z, obtain transformed x′, y′ coordinates and angle z′, and output them to the post-processing unit group; and

the post-processing unit group is configured to transform the x′, y′ coordinates and the angle z′ input by the core unit according to the other information k and a function f input by the pre-processing unit group to obtain an output result c.

Wherein, the pre-processing unit group comprises a selector 1 and a processor 2, and the post-processing unit group comprises a first post-processing unit 4, a second post-processing unit 5 and a third post-processing unit 6, both of which can be implemented through hardware integrated circuit (such as application-specific integrated circuit, namely, ASIC). The selector 1 receives the externally input independent variables a and the externally input function f, and determines which one of the following four different operations should to be taken, the details being set out as follows:

I. if, under the specification adopted for input or output, the error between the result of the linear or quadratic approximation of the independent variable a and the true value thereof is limited to the last bit of mantissa in a case that the result and the true value are respectively represented by floating-point numbers, resulting in that the independent variable a is too small, then the selector 1 directly outputs the independent variable a and the function f to the first post-processing unit 4 in the post-processing unit group, and the first post-processing unit 4 obtains a linear approximation formula of the independent variable a based on the function f, and performs addition and multiplication on the independent variable a to get the output result c (for the details, please see Table 1);

II. if the independent variable a is not beyond the convergence domain of the core unit; it is possible to reach the angle z=0 in a default mode or the ordinate y=0 in a vector mode within a limited number of steps; and the independent variable a can be directly accepted by a corresponding mode of the core unit 3, then the selector 1 obtains the x, y coordinates and the angle z of the independent variable a, and the mode to be used by the core unit according to the function f, and outputs the x, y, z, and the mode to the core unit 3; the core unit 3 performs trigonometric or hyperbolic transformation on the x, y, and z based on the mode, obtains transformed x′, y′ coordinates and an transformed angle z′, and outputs them to the second post-processing unit 5 in the post-processing unit group; and the second post-processing unit 5 obtains the output result c based on the x′, y′ coordinates and the angle z′ output by the core unit and the function f;

III. if the independent variable a cannot be directly accepted by a corresponding mode of the core unit, then the selector 1 hands over the independent variable a and the function f to the processor 2 for pre-processing, and the processor 2 performs information decomposition processing on the independent variable a according to the function f, and obtains the x, y coordinates, the angle z, the mode to be used by the core unit 3, and the other information k, wherein the x, y coordinates, the angle z, and the mode to be used by the core unit 3 are the same as those in II; the x, y coordinates, the angle z, and the mode to be used by the core unit 3 are output to the core unit 3; and the other information k and the function f are directly output to the third post-processing unit 6 in the post-processing unit group; the core unit 3 performs trigonometric or hyperbolic transformation on the x, y, and z based on the mode, obtains the x′, y′, and z′, and outputs them to the third post-processing unit 6 in the post-processing unit group; and the third post-processing unit 6 obtains the output result c based on the x′, y′, and z′ output by the core unit 3, the k given by the processor 2, and the function f; and

IV. if, under the specification adopted for input or output, the true value of the independent variable a exceeds the maximum range of the values represented by floating-point numbers, for example, as for IEEE754 half-precision floating-point number, the maximum range is the maximum absolute value of (1024+1023) or 1024×2³⁰⁻¹⁵=65504, then the selector 1 directly outputs the independent variable a and the function f (NaN). See Table 1 for the specific ranges for determination under the situations I, II, III and IV and the operations adopted in the four situations when respective input functions are operated by using IEEE754 half-precision (binary 16) floating-point numbers.

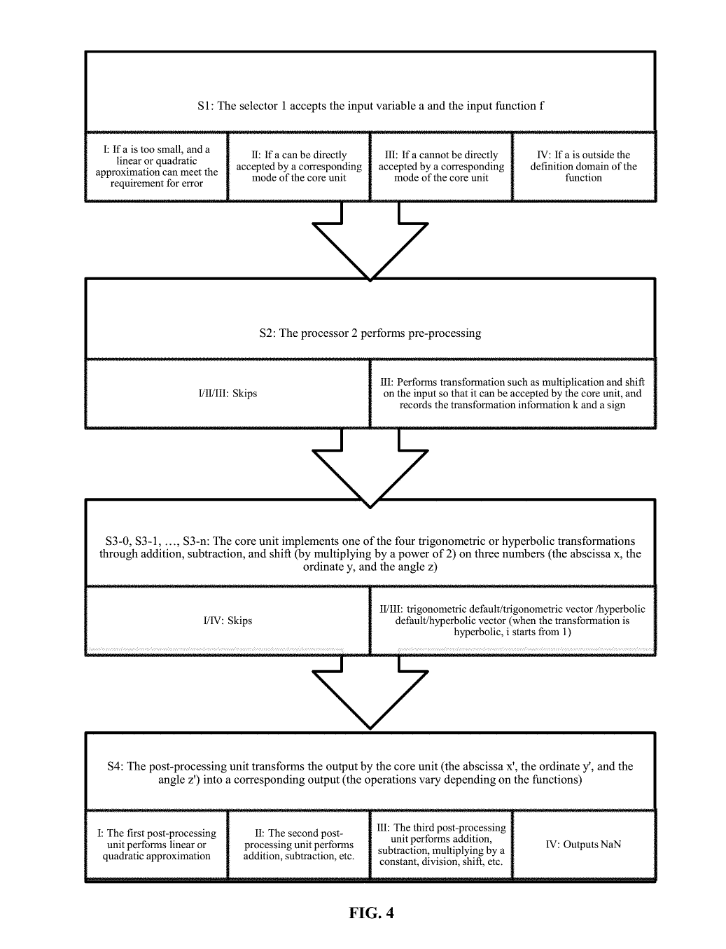

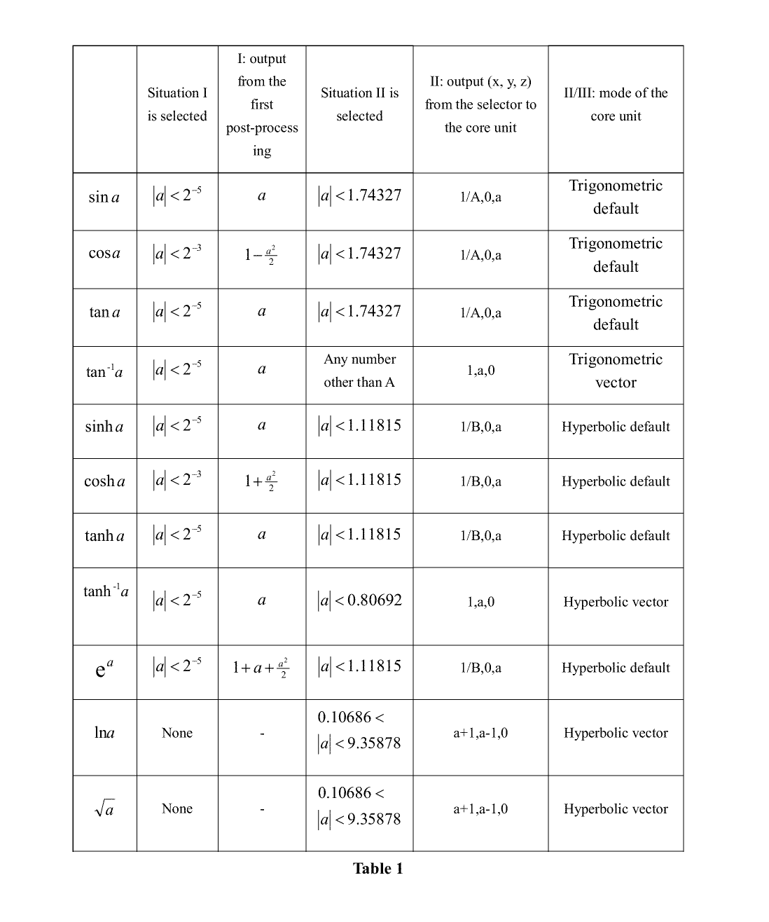

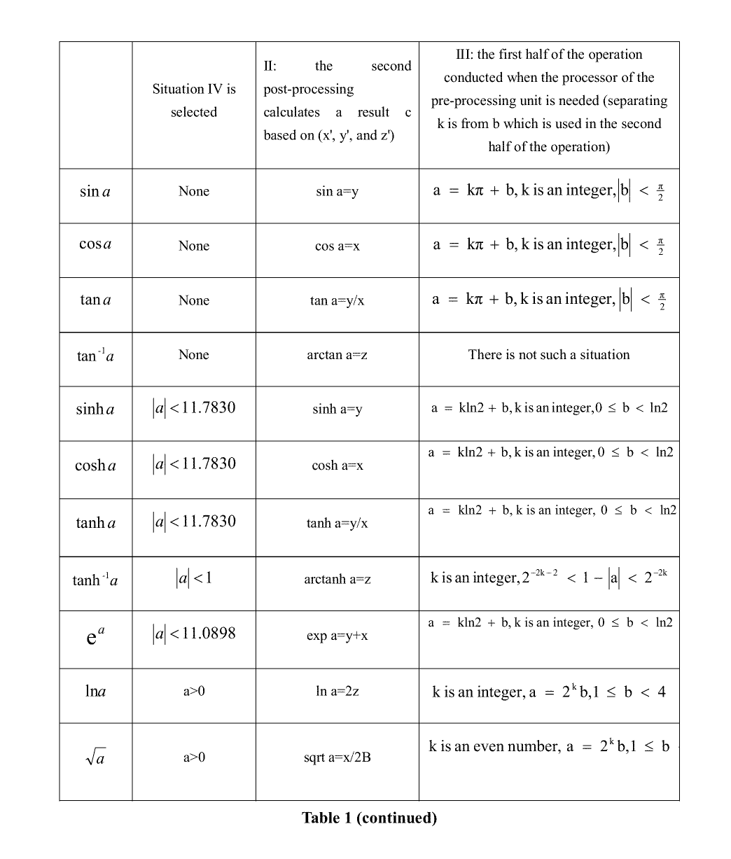

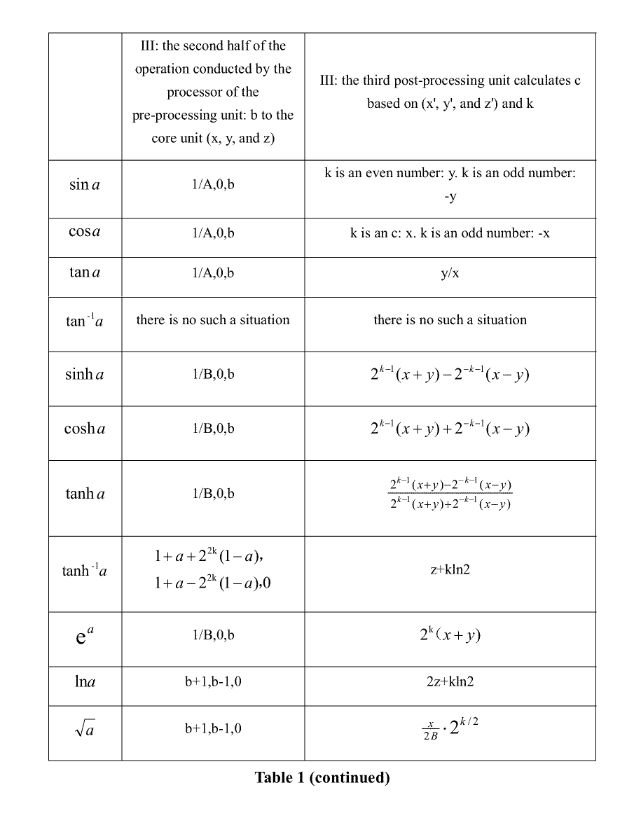

The embodiments of the present invention also provide a method for performing multiple transcendental function operations as shown in FIG. 4 (FIG. 4 shows a flowchart of the method for performing multiple transcendental function operations according to an embodiment of the present invention), comprising the following steps:

Step 1: the selector receives the input independent variable a and the input function f, and determines which one of the four different operations, namely, Type I, Type II, Type III, and Type IV should be adopted;

I. if, under the specification adopted for input or output, the error between the result of the linear or quadratic approximation of the independent variable a and the true value thereof is limited to the last bit of mantissa in a case that the result and the true value are respectively represented by floating-point numbers, resulting in that the independent variable a is too small, then the selector directly outputs the independent variable a and the function f to the first post-processing unit in the post-processing unit group, and the first post-processing unit obtains a linear approximation formula of the independent variable a based on the function f, and performs addition and multiplication on the independent variable a to get the output result c (for the details, please see Table 1);

II. if the independent variable a is not beyond the convergence domain of the core unit; it is possible to reach the angle z=0 in a default mode or the ordinate y=0 in a vector mode within a limited number of steps; and the independent variable a can be directly accepted by a corresponding mode of the core unit, then the selector obtains the x, y coordinates and the angle z of the independent variable a, and the mode to be used by the core unit according to the function f, and outputs the x, y, z, and the mode to the core unit; the core unit performs trigonometric or hyperbolic transformation on the x, y, and z based on the mode, obtains transformed x′, y′ coordinates and an transformed angle z′, and outputs them to the second post-processing unit in the post-processing unit group; and the second post-processing unit obtains the output result c based on the x′, y′ coordinates and the angle z′ output by the core unit and the function f;

III. if the independent variable a cannot be directly accepted by a corresponding mode of the core unit, then the selector hands over the independent variable a and the function f to the processor for pre-processing, and the processor performs information decomposition processing on the independent variable a according to the function f, and obtains the x, y coordinates, the angle z, the mode to be used by the core unit, and the other information k, wherein the x, y coordinates, the angle z, and the mode to be used by the core unit are the same as those in II; the x, y coordinates, the angle z, and the mode to be used by the core unit are output to the core unit; and the other information k and the function f are directly output to the third post-processing unit in the post-processing unit group; the core unit performs trigonometric or hyperbolic transformation on the x, y, and z based on the mode, obtains the x′, y′, and z′, and outputs them to the third post-processing unit in the post-processing unit group; and the third post-processing unit obtains the output result c based on the x′, y′, and z′ output by the core unit, the k given by the processor, and the function f; and

IV. if, under the specification adopted for input or output, the true value of the independent variable a exceeds the maximum range of the values represented by floating-point numbers, for example, as for IEEE754 half-precision floating-point number, the maximum range is the maximum absolute value of (1024+1023) or 1024×2³⁰⁻¹⁵=65504, then the selector directly outputs the independent variable a and the function f (NaN). See Table 1 for the specific ranges for determination under the situations I, II, III and IV and the operations adopted in the four situations when respective input functions are operated by using IEEE754 half-precision (binary 16) floating-point numbers.

Step 2: when the processor adopts the Type III operation, the processor performs multiplication or shift transformation on the input independent variable a and the input function f so that they can be accepted by the core unit, and records transformation information k and a sign for use by the third post-processing unit, wherein the sign is valid only in some functions (for the specific operations of the processor under the conditions of respective input functions, please see Table 1);

Step 3: when the processor adopts the Type II or Type III operation, the core unit implements the following four types of trigonometric or hyperbolic transformations by addition, subtraction, and shift operations on three numbers, i.e., the abscissa x, the ordinate y, and the angle z:

$$Trigonometric default \text{:}$$

$$( x , y , z ) \to ( A ( x cos z - y sin z ) , A ( y cos z + x sin z ) , 0 )$$

$$Trigonometric vector \text{:} ( x , y , 0 ) \to ( A \sqrt{{x}^{2} + {y}^{2}} , 0 , arc tan \frac{y}{x} )$$

$$Hyperbolic default \text{:}$$

$$( x , y , z ) \to ( B ( x cos h z + y sinh z ) , B ( y cosh z + x sinh z ) , 0 )$$

$$Hyperbolic vector \text{:} ( x , y , 0 ) \to ( B \sqrt{{x}^{2} - {y}^{2}} , 0 , arc tanh \frac{y}{x} )$$

wherein in the above formulae, A and B are constants related to the selected number of iterations, and the shift operation is to multiply by a power of 2; and the transformation is carried out by iterating to approximate to the rotation angle which should be performed;

whether the rotation angle zᵢ in a step i is forward or backward is determined as below: in the default mode, the target z=0, so when z>0, forward rotation is performed, and when z<0, backward rotation is performed; in the vector mode, the target y=0, so when y>0, backward rotation is performed, and when y<0, forward rotation is performed;

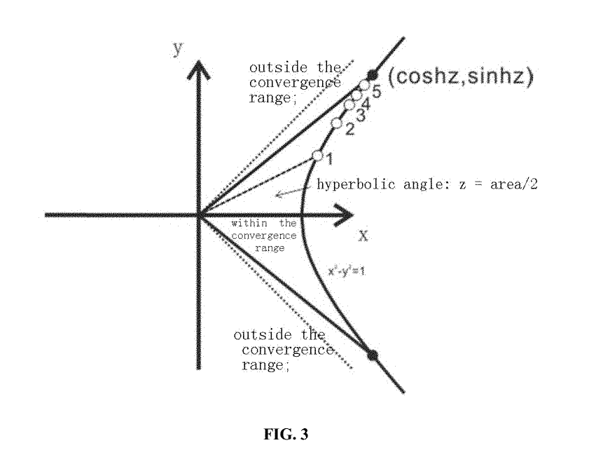

FIG. 2 shows intuitively the principle that a series of trigonometric transformation at fixed angles is used to approximate the target trigonometric transformation (for convenience, each step of enlarging the abscissa and the ordinate by 1/cos zᵢ is not shown). FIG. 3 intuitively shows the principle that a series of hyperbolic transformation at fixed angles is used to approximate the target hyperbolic transformation (for convenience, each step of enlarging the abscissa and the ordinate by 1/cos h zᵢ is not shown).

each iteration is equivalent to performing forward or backward rotation by the angle zᵢ and enlarging the abscissa and the ordinate by 1/cos zᵢ, wherein in the hyperbolic mode, they are enlarged by 1/cos hzᵢ:
Trigonometric forward: (x, y, z)→((x−y tan zᵢ), (y+x tan zᵢ), z−zᵢ)
Trigonometric backward: (x, y, z)→((x+y tan zᵢ), (y−x tan zᵢ), z+zᵢ)
Hyperbolic forward: (x, y, z)→((x+y tan hzᵢ), (y+x tan hzᵢ), z−zᵢ)
Hyperbolic backward: (x, y, z)→((x−y tan hzᵢ), (y−x tan hzᵢ), z+zᵢ)

wherein in order to implement each iteration and convergence by using addition, subtraction and shift only, the following sequences should be adopted for zᵢ:
Trigonometric: zᵢ=arctan 2⁻ⁱ, i=0, 1, 2, . . .
Hyperbolic: zᵢ=arctan h2^{-j}, j=i-k, when (3^{k+1}−1)/2+k≤i≤(3^{k+2}−1)/2+k+1, i=1, 2, 3, . . .

wherein the specific number of iterations, i.e., the maximum value of i, is flexibly selected based on the precision of the processed floating point number, and after the maximum number of iterations is selected, the aforementioned constants can be calculated:

$$A = {\prod }_{i = 0}^{max} \frac{1}{cos {z}_{i}} , B = {\prod }_{i = 1}^{max} \frac{1}{cosh {z}_{i}} .$$

For a selection from the above four modes under the conditions of respective input functions, please see Table 1.

Step 4a: when the processor adopts the Type I operation, the first post-processing unit calculates a linear or quadratic approximation according to the input function f and outputs the approximation (for the specific operations conducted by the first post-processing unit under the conditions of respective input functions, please see Table 1); and

Step 4b: when the processor adopts the Type II or Type III operation, the second post-processing unit performs addition, subtraction, multiplying by a constant, division, and shift operations on the output of the core unit according to the input function f and the information provided by the processor of the pre-processing unit group, and obtains the output result c, wherein the information provided by the processor of the pre-processing unit group is valid only in the Type III operation (for the specific operation conducted by the second post-processing unit under the conditions of respective input functions, please see Table 1).

As known from the above description, the apparatus and the method for performing multiple transcendental function operations provided by the present invention coverts evaluation of transcendental functions into getting the results of trigonometric or hyperbolic rotation transformation; adopts the manner of iteration to ensure a fixed absolute value of the angle of each rotation; performs backward rotation when the rotation is excessive and performs forward rotation when the rotation is insufficient, so that it is only necessary to store a series of fixed coefficients and define an angle sequence zᵢ to make tan zᵢ (tan hzᵢ in the case of hyperbolic transformation) a power of 2, so that the multiplication of them by the x, y coordinates can be implemented by much simpler shifting. Accordingly, it reduces waste of time or power consumption caused by multiplication performed between each two of variables, and guarantees the required precision, and thus it can carry out calculations of various trigonometric, hyperbolic, exponential, and logarithmic functions, solves the problems of excessive overheads in the general-purpose processor manner and poor precision in the pure linear approximation manner, and efficiently strengthens the support for various transcendental function operations.

The processes or methods depicted in the foregoing drawings may be implemented by the processing logic including hardware (e.g., circuit, dedicated logic, etc.), firmware, software (e.g., software embodied in a non-transitory computer-readable medium), or combinations thereof. Although the processes or methods are described above in certain orders, it should be understood that some of the described operations can be performed in a different order. In addition, certain operations may be performed in parallel rather than sequentially.

In the foregoing specification, each embodiment of the present invention is described with reference to the specific exemplary embodiment thereof. Obviously, various modifications to the embodiments may be made without departing from the broader spirit and scope of the invention as set forth in the appended claims. Accordingly, the specification and drawings should be regarded as being illustrative rather than restrictive.

1. An apparatus for performing multiple transcendental function operations, comprising:
a pre-processing unit group configured to:
transform an externally input independent variable a into a first coordinate, a second coordinate, an angle z, and other information k;
a core unit is configured to perform a transformation on the first coordinate x, the second coordinate y, and the angle z, obtain a transformed first coordinate x′, a transformed second coordinate y′, and a transformed angle z′; and
a post-processing unit group is configured to transform the transformed first coordinate x′, the transformed second coordinate y′, and the transformed angle z′ input by the core unit according to the other information k and a function f input by the pre-processing unit group to obtain an output result c.

2. The apparatus for performing multiple transcendental function operations according to claim 1,
wherein said pre-processing unit group comprises a selector and a processor, and said post-processing unit group comprises a first post-processing unit, a second post-processing unit and a third post-processing unit,
wherein the selector is configured to
receive the externally input independent variables a and the externally input function f, and
select one from a first operation, a second operation, a third operation, and a fourth operation.

3. The apparatus for performing multiple transcendental function operations according to claim 2, wherein
a true value of the independent variable a exceeds a maximum range of the values represented by floating-point numbers in accordance with IEEE754 half-precision floating-point number standard.

4. A method for performing multiple transcendental function operations, the method comprising:
receiving, by a selector, the input independent variable a and the input function f,
selecting, by the selector, one of the four operations including Type I, Type II, Type III, and Type IV;
performing, by a processor, multiplication or shift transformation on the input independent variable a and the input function f based on a determination that the Type III operation is selected;
implementing, by a core unit, the four types of transformation by addition, subtraction, and shift operations on three numbers including the abscissa x, the ordinate y, and the angle z based on a determination that the Type II operation is selected, wherein the four types of transformation include
$$Trigonometric default \text{:}$$
$$( x , y , z ) \to ( A ( x cos z - y sin z ) , A ( y cos z + x sin z ) , 0 )$$
$$Trigonometric vector \text{:} ( x , y , 0 ) \to ( A \sqrt{{x}^{2} + {y}^{2}} , 0 , arc tan \frac{y}{x} )$$
$$Hyperbolic default \text{:}$$
$$( x , y , z ) \to ( B ( x cos h z + y sinh z ) , B ( y cosh z + x sinh z ) , 0 )$$
$$Hyperbolic vector \text{:} ( x , y , 0 ) \to ( B \sqrt{{x}^{2} - {y}^{2}} , 0 , arc tanh \frac{y}{x} )$$
wherein A and B are constants related to the selected number of iterations, and the shift operation is to be multiplied by a power of 2;
calculating, by a first post-processing unit, a linear or quadratic approximation according to the input function f and outputs the approximation based on a determination that the Type I operation is selected; and
performing, by a second post-processing unit, addition, subtraction, multiplying by a constant, division, and shift operations on the output of the core unit based on a determination that the Type III operation is selected according to the input function f and the information provided by the processor of the pre-processing unit group, and
obtaining by the second post-processing unit, the output result c, wherein the information provided by the processor of the pre-processing unit group is valid only in the Type III operation.

5. The method for performing multiple transcendental function operations according to claim 4, wherein said Type I operation includes:
if, under the specification adopted for input or output, the error between the result of the linear or quadratic approximation of the independent variable a and the true value thereof is limited to the last bit of mantissa in a case the result and the true value are respectively represented by floating-point numbers, resulting in that the independent variable a is too small, then the selector directly outputs the independent variable a and the function f to the first post-processing unit in the post-processing unit group, and the first post-processing unit obtains a linear approximation formula of the independent variable a based on the function f, and performs addition and multiplication on the independent variable a to get the output result c.

6. The method for performing multiple transcendental function operations according to claim 4, wherein said Type II operation includes:
if the independent variable a is not beyond the convergence domain of the core unit; it is possible to reach the angle z=0 in a default mode or the ordinate y=0 in a vector mode within a limited number of steps; and the independent variable a can be directly accepted by a corresponding mode of the core unit, then the selector obtains the x, y coordinates and the angle z of the independent variable a, and the mode to be used by the core unit according to the function f, and outputs the x, y, z, and the mode to the core unit; the core unit performs trigonometric or hyperbolic transformation on the x, y, and z based on the mode, obtains transformed x′, y′ coordinates and an transformed angle z′, and outputs them to the second post-processing unit in the post-processing unit group; and the second post-processing unit obtains the output result c based on the x′, y′ coordinates and the angle z′ output by the core unit and the function f.

7. The method for performing multiple transcendental function operations according to claim 4, wherein said Type III operation includes:
if the independent variable a cannot be directly accepted by a corresponding mode of the core unit, then the selector hands over the independent variable a and the function f to the processor for pre-processing, and the processor performs information decomposition processing on the independent variable a according to the function f, and obtains the x, y coordinates, the angle z, the mode to be used by the core unit, and the other information k, wherein the x, y coordinates, the angle z, and the mode to be used by the core unit are the same as those in II; the x, y coordinates, the angle z, and the mode to be used by the core unit are output to the core unit; and the other information k and the function f are directly output to the third post-processing unit in the post-processing unit group; the core unit performs trigonometric or hyperbolic transformation on the x, y, and z based on the mode, obtains the x′, y′, and z′, and outputs them to the third post-processing unit in the post-processing unit group; and the third post-processing unit obtains the output result c based on the x′, y′, and z′ output by the core unit, the k given by the processor, and the function f.

8. The method for performing multiple transcendental function operations according to claim 4, wherein said Type IV operation being set out as follows:
if, under the specification adopted for input or output, the true value of the independent variable a exceeds the maximum range of the values represented by floating-point numbers, then the selector directly outputs the independent variable a and the function f.

9. The method for performing multiple transcendental function operations according to claim 4, wherein said core unit implements the following four types of trigonometric or hyperbolic transformation by addition, subtraction, and shift operations on three numbers, the abscissa x, the ordinate y, and the angle z:
whether the rotation angle zᵢ in a step i is forward or backward is determined as below: in the default mode, the target z=0, so when z>0, forward rotation is performed, and when z<0, backward rotation is performed; in the vector mode, the target y=0, so when y>0, backward rotation is performed, and when y<0, forward rotation is performed;
each iteration is equivalent to performing forward or backward rotation by the angle zᵢ and enlarging the abscissa and the ordinate by 1/cos zᵢ, wherein in the hyperbolic mode, they are enlarged by 1/cos h zᵢ;
Trigonometric forward: (x, y, z)→((x−y tan zᵢ), (y+x tan zᵢ), z−zᵢ)
Trigonometric backward: (x, y, z)→((x+y tan zᵢ), (y−x tan zᵢ), z+zᵢ)
Hyperbolic forward: (x, y, z)→((x+y tan hzᵢ), (y+x tan hzᵢ), z−zᵢ)
Hyperbolic backward: (x, y, z)→((x−y tan hzᵢ), (y−x tan hzᵢ), z+zᵢ)
wherein in order to implement each iteration and convergence by using addition, subtraction and shift only, the following sequences should be adopted for zᵢ:
Trigonometric: zᵢ=arctan 2⁻ⁱ, i=0, 1, 2, . . .
Hyperbolic: zᵢ=arctan h2^{-j}, j=i-k, when (3^{k+1}−1)/2+k≤i≤(3^{k+2}−1)/2+k+1, i=1, 2, 3, . . .
wherein the specific number of iterations, i.e., the maximum value of i, is flexibly selected based on the precision of the processed floating point number, and after the maximum number of iterations is selected, the aforementioned constants can be calculated:
$$A = {\prod }_{i = 0}^{max} \frac{1}{cos {z}_{i}} , B = {\prod }_{i = 1}^{max} \frac{1}{cosh {z}_{i}} .$$

10. The apparatus of claim 1, wherein the transformation is a trigonometric transformation.

11. The apparatus of claim 1, wherein the transformation is a hyperbolic transformation.

12. The apparatus of claim 2, wherein the first operation includes, if, under the specification adopted for input or output, the error between the result of the linear or quadratic approximation of the independent variable a and the true value thereof is limited to the last bit of mantissa in a case the result and the true value are respectively represented by floating-point numbers, resulting in that the independent variable a is too small, then the selector directly outputs the independent variable a and the function f to the first post-processing unit in the post-processing unit group, and the first post-processing unit obtains a linear approximation formula of the independent variable a based on the function f, and performs addition and multiplication on the independent variable a to get the output result c.

13. The apparatus of claim 2, wherein the second operation includes if the independent variable a is not beyond the convergence domain of the core unit (3); it is possible to reach the angle z=0 in a default mode or the ordinate y=0 in a vector mode within a limited number of steps; and the independent variable a can be directly accepted by a corresponding mode of the core unit, then the selector obtains the x, y coordinates and the angle z of the independent variable a, and the mode to be used by the core unit according to the function f, and outputs the x, y, z, and the mode to the core unit; the core unit performs trigonometric or hyperbolic transformation on the x, y, and z based on the mode, obtains transformed x′, y′ coordinates and an transformed angle z′, and outputs them to the second post-processing unit in the post-processing unit group; and the second post-processing unit obtains the output result c based on the x′, y′ coordinates and the angle z′ output by the core unit and the function f.

14. The apparatus of claim 2, wherein the third operation includes if the independent variable a cannot be directly accepted by a corresponding mode of the core unit, then the selector hands over the independent variable a and the function f to the processor for pre-processing, and the processor performs information decomposition processing on the independent variable a according to the function f, and obtains the x, y coordinates, the angle z, the mode to be used by the core unit, and the other information k, wherein the x, y coordinates, the angle z, and the mode to be used by the core unit (3) are the same as those in II; the x, y coordinates, the angle z, and the mode to be used by the core unit are output to the core unit; and the other information k and the function f are directly output to the third post-processing unit in the post-processing unit group; the core unit performs trigonometric or hyperbolic transformation on the x, y, and z based on the mode, obtains the x′, y′, and z′, and outputs them to the third post-processing unit in the post-processing unit group; and the third post-processing unit obtains the output result c based on the x′, y′, and z′ output by the core unit, the k given by the processor, and the function f.

15. The apparatus of claim 2, wherein the fourth operation includes if, under the specification adopted for input or output, the true value of the independent variable a exceeds the maximum range of the values represented by floating-point numbers, then the selector directly outputs the independent variable a and the function f.
